(19) United States
(12) Patent Application Publication
(10) Pub. No.: US 2014/0226975 A1
(43) Pub. Date: Aug. 14, 2014

(54) METHOD AND APPARATUS FOR BOOSTING DATA INTENSIVE PROCESSING THROUGH OPTICAL CIRCUIT SWITCHING

(71) Applicant: Sodero Networks, Inc., Cranbury, NJ (US)

(72) Inventors: Yueping ZHANG, Princeton, NJ (US); Lei XU, Princeton Junction, NJ (US)

(73) Assignee: SODERO NETWORKS, INC., Cranbury, NJ (US)

(21) Appl. No.: 14/177,807

(22) Filed: Feb. 11, 2014

Related U.S. Application Data
(60) Provisional application No. 61/764,237, filed on Feb. 13, 2013.

(51) Int. Cl. H04B 10/079

(52) U.S. Cl. CPC H04B 10/0793
USPC 398/25

(57) ABSTRACT

A method is provided for improving performance of a distributed computing task being executed by computing devices interconnected by an optical switching fabric. Traffic flows between a plurality of nodes of a MapReduce application using an interconnected optical switching fabric are monitored. One or more optimizations for the interconnected optical switching fabric are determined based on the monitoring of the traffic flows. The interconnected optical switching fabric is reconfigured to implement the one or more determined optimizations.

### CROSS-REFERENCE TO RELATED APPLICATIONS

This application claims priority to U.S. Provisional Patent Application No. 61/764,237 filed Feb. 13, 2013, which is incorporated herein by reference.

### BACKGROUND OF THE INVENTION

Embodiments of the present invention relate generally to computer network management and high-performance distributed computing, and more particularly to intelligent and self-optimizing big data processing platforms enabled by optical switching technologies and methods for achieving such functionalities.

Data intensive computation has evolved from conventional high-performance computing (e.g., mainframes and supercomputers) to today's distributed computing. Today, the map/reduce computing framework is the de facto standard for data-intensive computation and is widely deployed in enormous government, enterprise, and research organizations.

Referring to FIG. 1, an exemplary prior art map/reduce platform is shown. The map/reduce platform includes a plurality of map/reduce servers 101 and a map/reduce controller 103. A map/reduce server may assume different roles, such as processing distributed sub-tasks (i.e., Mapper), aggregating intermediate results of the sub-tasks (i.e., Reducer), or storing data for the distributed file system (i.e., DFS node). The map/reduce servers 101 and the map/reduce controller 103 communicate with each other through an interconnect network 102. The map/reduce controller 103 schedules map/reduce tasks, indexes the distributed file system (DFS), and dispatches the map/reduce tasks to the map/reduce servers 101.

The map/reduce controller 103 assigns tasks to servers mainly based on the availability of the servers, while paying limited consideration to the network situation of the interconnect network 102. Map/reduce applications usually involve massive data movement across server racks, and therefore have high performance requirements of the underlying network infrastructure. As a consequence, the task scheduler in the native map/reduce controller 103 suffers from bursty network traffic, network congestion, and degraded application performance.

Existing efforts to enhance the performance of the map/reduce framework mainly focus on modifying the map/reduce task scheduler of the map/reduce controller 103 to take into account data locality and network congestion. Other efforts focus on improving the task scheduler's failure recovery and replication mechanisms. However, such efforts are not able to take into account the network status of the interconnect network 102.

Accordingly, it is desirable to dynamically and proactively change the routing of network flows and capacity of individual links in the interconnect network 102 to avoid network congestion based on real-time predictions of data movement. It is further desirable to interact with and retrieve data movement information from the map/reduce controller 103, thereby identifying network hotspots, change flow routing paths, and reallocating link capacity to resolve network congestion.

### SUMMARY OF THE INVENTION

In one embodiment, a method for optimizing an interconnected optical switching fabric. Traffic flows between a plurality of nodes of a map/reduce application using an interconnected optical switching fabric are monitored. One or more optimizations for the interconnected optical switching fabric are determined based on the monitoring of the network traffic flows. The interconnected optical switching fabric is reconfigured to implement the one or more determined optimizations.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

FIG. 1 is a block diagram of an exemplary prior art map/reduce computing platform.

FIG. 2 is a block diagram of an exemplary system having a middleware for boosting data intensive processing through optical circuit switching according to one preferred embodiment of this invention;

FIG. 3 is a block diagram of the structure of the middleware of FIG. 2 according to one preferred embodiment of this invention;

FIG. 4 is a block diagram of the reconfigurable optical network switching fabric of FIG. 2 according to one preferred embodiment of this invention;

FIG. 5 is a block diagram of the data collector module of the middleware of FIG. 3 according to one preferred embodiment of this invention;

FIG. 6 is a block diagram of the network scheduling engine of the middleware of FIG. 3 according to one preferred embodiment of this invention.

FIG. 7 is a flowchart of steps for dynamically scheduling network flows to resolve network congestion adaptively according to the preferred embodiment of this invention.

FIG. 8 is a block diagram of a network analyzer of FIG. 3 having a plurality of inputs and outputs according to the preferred embodiment of this invention.

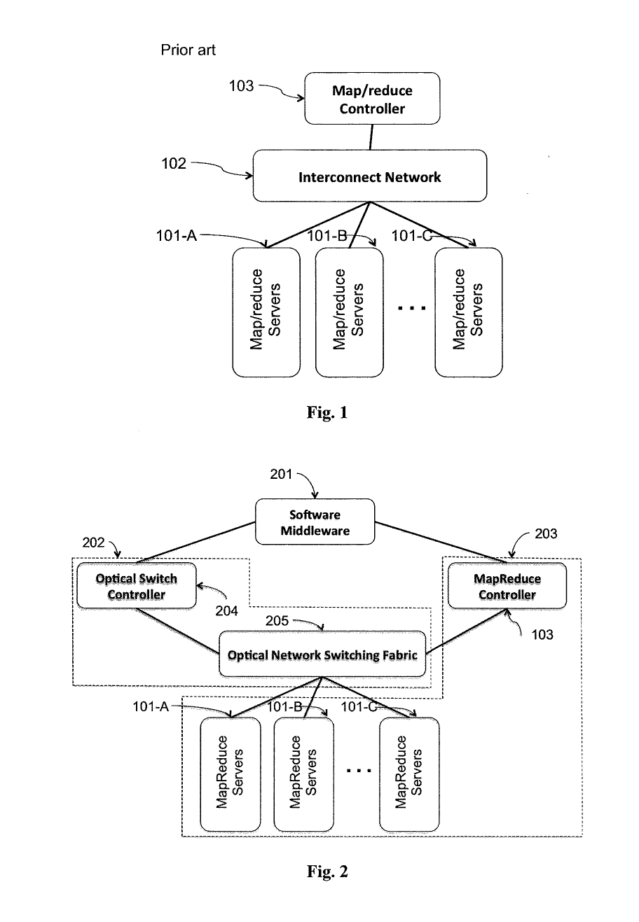

### DETAILED DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

The present invention will be described in detail with reference to the drawings. The figures and examples below are not meant to limit the scope of the present invention to a single embodiment, but other embodiments are possible by way of interchange of some or all of the described or illustrated elements. Moreover, where some of the elements of the present invention can be partially or fully implemented using known components, only portions of such known components that are necessary for an understanding of the present invention will be described, and a detailed description of other portions of such known components will be omitted so as not to obscure the invention.

The present disclosure relates to a big data computer processing platform, such as the map/reduce framework implemented on an optical switched data center network. Various map/reduce frameworks, such as APACHE HADOOP and GOGGLE MAPREDUCE, are known to those in the art. Such software platforms may be implemented in particular embodiments of this invention without departing from the scope thereof. In the preferred embodiment, the present system is described with reference to, and in the context of, the APACHE HADOOP map/reduce framework. However, those skilled in the art will understand that the disclosed methods and systems can be easily extended to other commercial or open-source distributed data processing platforms.

In the preferred embodiment, a middleware is provided that runs on data center networks that employ optical circuit switching. Preferably, the middleware dynamically and proactively changes the routing of network flows and capacity of individual links to avoid or reduce the severity of network congestion by predicting data movement between Mappers, Reducers and DFS nodes in a map/reduce system in real time. Network flow routing and link capacity adjustments are achieved through reconfiguration of the optical switches used in the data center network.

Referring to the drawings in detail, wherein like reference numerals indicate like elements throughout, FIG. 2 is a block diagram of an exemplary system having a middleware 201 for boosting data intensive processing of a map/reduce computing platform 203 through optical circuit switching. Preferably, the map/reduce computing platform 203 is communicatively coupled to, or deployed on, an optical switching system 202. Components and implementation of the all-optical switching system according to the preferred embodiment are described in more detail in co-pending U.S. Patent Application Ser. No. 61/719,026, now U.S. patent application Ser. No. 14/057,133, which is incorporated by reference herein in its entirety.

The map/reduce computing platform 203 and the optical switching system 202 are coupled to an intelligent network middleware 201. The middleware 201 leverages the switching mechanism and reconfigurability of the optical switch units (not shown) in the optical network switching fabric 205, allowing the middleware 201 to dynamically and proactively change the routing of network flows and capacity of individual links to avoid network congestion based on real-time prediction of data movement between the nodes (e.g., Mappers, Reducers, and DFS) of the map/reduce computing platform 203. The middleware 201 interacts with the map/reduce controller 103 to retrieve data movement information therefrom. The retrieved data movement information allows the middleware 201 to identify network hotspots, change flow routing paths, and reallocate link capacity to resolve network congestion.

The optical switching system 202 includes a central controller 204 and an Optical Switching Fabric 205. The Optical Switching Fabric 205 interconnects a plurality of map/reduce servers 101. The map/reduce servers 101 serve as the worker nodes for computing tasks and/or as the storage nodes for the Distributed File System (DFS). Preferably, a worker node is a physical or virtual machine that executes a map or reduce task, and a storage node is a physical or virtual machine that stores data and serves as a portion of the DFS. In practice, a worker node and a storage node may reside on the same physical machine.

All the worker nodes (e.g., the TaskNode in HADOOP) and storage nodes (e.g., the Datallode in HADOOP) are managed by the job controller node (e.g., the JobTracker in HADOOP) and the storage controller node (e.g., the NameNode in HADOOP). The job controller node and the storage controller node may both reside on the same physical or virtual server, and are collectively referred to as the map/reduce controller 103 herein.

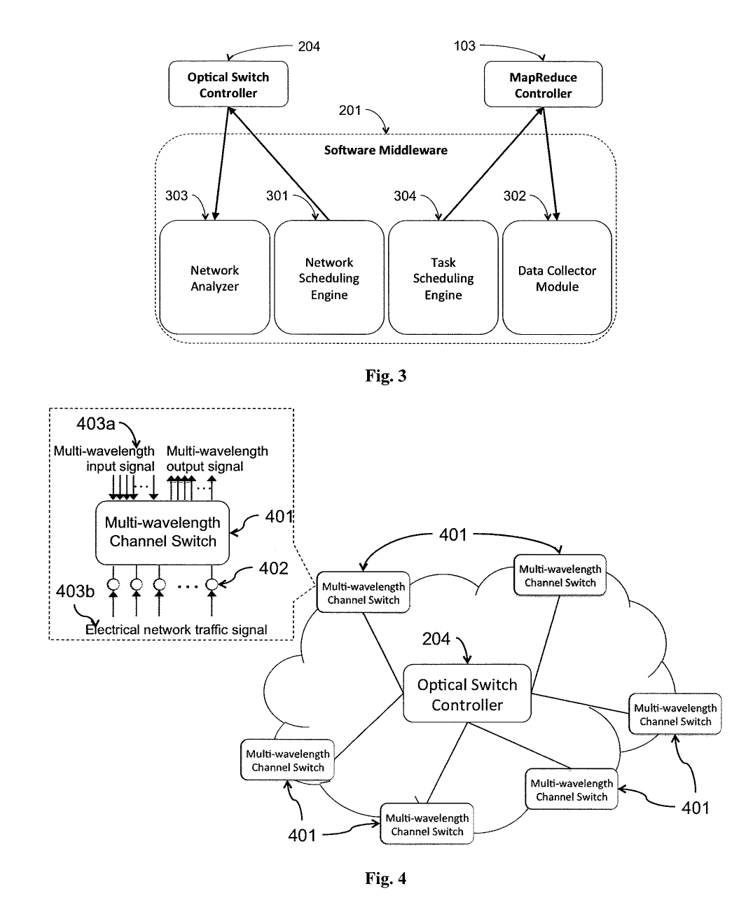

Referring now to FIG. 3, a block diagram of the middleware of FIG. 2 is shown. The middleware 201 includes four main components, a network scheduling engine 301, a data collector module 302, a network analyzer 303, and a task scheduling engine 304. The data collector module 302 preferably resides on the map/reduce computing platform 203. The map/reduce computing platform 203 periodically collects the source and destination, data volume, and transfer progress of all network flows, including flows that have not started yet. Preferably, the data collector module 302 includes an agent (not shown) running on the map/reduce worker node(s), which are running on the map/reduce servers 101. The agent of the data collector module 302 functions to infer upcoming data transfers and data volume before the transfers actually take place.

The network analyzer 303 identifies network hotspots or network segments where application performance degradation is happening or is likely to happen. The identifying of network hotspots or network segments is preferably based on the current flow routing configurations and network physical properties (e.g., topology, link capacity, and the like). The task scheduling engine 304 suggests alternative task scheduling policies for the map/reduce controller 103 to improve the application performance based on the network situation generated by the network analyzer 303.

The network scheduling engine 301 takes as input the network topology and data movement prediction generated by the data collector module 302 and proactively provisions the network 205. Furthermore, the network scheduling engine 301 resolves any potential network contention issues. These actions (e.g., routing reassignment and link capacity reallocation) generated by the network scheduling engine 301 are input into the optical switch controller 204. The optical switch controller 204 translates the actions generated by the network scheduling engine 301 into control commands that can be understood and actuated by the underlying optical switching fabric 205.

The optical switching fabric 205 includes a plurality of interconnected multi-wavelength optical channel switches 401, as shown in FIG. 4. The optical channel switches 401 may be implemented in a plurality of ways. For example, the optical channel switches 401 may be implemented with wavelength selective switching or optical space switching. However, other technologies for implementing the optical channel switches 401 are known to those skilled in the art and are within the scope of this disclosure.

A multi-wavelength optical channel switch 401 takes as input two types of multiple channels of optical signals. The first input 403a to the optical channel switch 401 is network traffic originated from other multi-wavelength optical channel switches 401. The second input 403b to the optical channel switch 401 is network traffic which originated from map/reduce servers 101 under the same optical channel switch 401. The input optical signal is converted from electrical signals by the optical-electrical (OE) converter 402. All the multi-wavelength optical channel switches 401 are interconnected based on a particular network architecture.

An exemplary architecture of the interconnected multi-wavelength channel switches 401 of FIG. 4 is described in further detail in co-pending U.S. Patent Application Ser. No. 61/719,026, now U.S. patent application Ser. No. 14/057,133. The topology includes, but is not limited to, the multi-dimensional architecture described in the co-pending patent application. All the multi-wavelength optical channel switches 401 are controlled by one or more optical switch controllers 204. The optical switch controller 204 preferably dynamically reconfigures the network routing paths, physical topology, and link capacities to resolve network congestion and contention in a timely and dynamic manner.

The optical switching system 202 takes a network traffic matrix (i.e., network bandwidth demand between each pair of map/reduce servers 101) as its input. The network traffic matrix can be obtained from a separate network monitoring module (not shown) or specified by a network administrator, operator or the like. The optical switching system 202 decides and implements reconfiguration of the multi-wavelength channel switches 401 in order to adaptively optimize network performance. After the reconfiguration process finishes, the optical switch controller 204 returns the reconfiguration results (e.g., flow routing information and setup of the multi-wavelength optical channel switches 401) to the network analyzer 303. The network analyzer 303 further processes and translates the results into the expected network situation, which can be obtained by for each network link aggregating the traffic volume of all flows traversing that link. The expected network situation information is then fed into the task scheduling engine 304. The task scheduling engine 304 generates task rescheduling suggestions based on the network situation input by the network analyzer 303 and the task scheduling and execution information input by the data collector module 302. The generated task rescheduling suggestions further improve the performance of applications that are currently being performed by the map/reduce servers 101. Preferably, the task scheduling engine 304 inputs the task rescheduling suggestions to the map/reduce controller 103. The map/reduce controller 103 preferably incorporates these suggestions into its current task schedules.

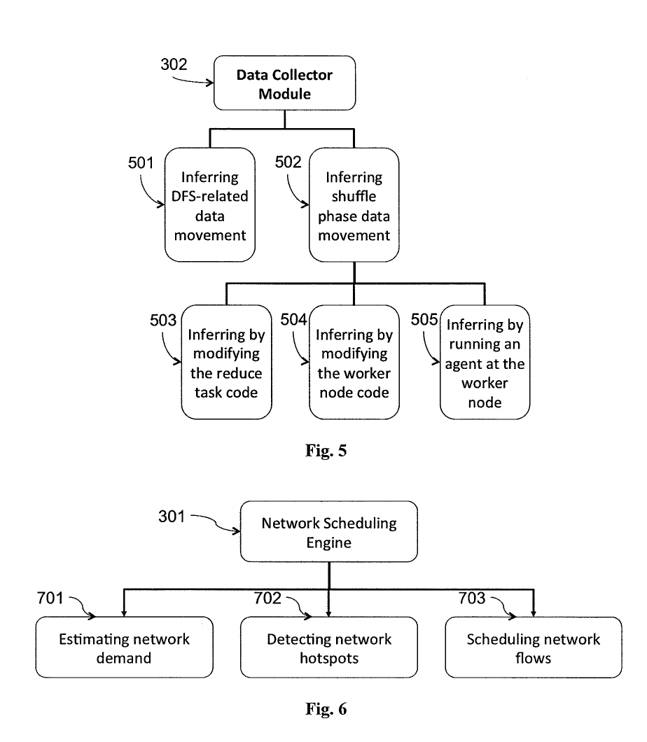

Referring back to FIG. 3, the data collector module 302 proactively infers the source and destination, and the data volume of map/reduce flows between the source and destination map/reduce servers 101 before the transfer of the flows actually happens. Data movements in map/reduce applications mainly occur during two operations, writing/replicating data to the DFS, and shuffling the MAP outputs to the reducers. As illustrated in FIG. 5, the data collector module 302 utilizes a first procedure for inferring DFS-related data movement 501, and a second procedure for inferring shuffle phase data movement 502 to cope with these two situations, respectively. The procedures will now be described in further detail.

In the DFS-related data movement 501 procedure, any form of update or modification in the DFS goes through the map/reduce controller 103 (i.e., the NameNode in HADOOP), which decides what storage node (i.e., the DataNode in HADOOP) are responsible for storing which data blocks. The map/reduce controller 103 maintains tables containing information about which block belong to which file, and which block is stored in which storage node, so that it can reconstruct the file when needed. Thus, information about data writes to DFS can be extracted from the map/reduce controller 103.

In the shuffle phase data movement 502 procedure, the data movement information is extracted during the map/reduce shuffle phase before the transfers take place. In this phase, each mapper is responsible for a single split/block of data. So the total number of MAP tasks is equal to the total input file size or the block size. In one embodiment, reducers start after a certain fraction of the mappers finish (e.g., HADOOP version 0.21 and higher). By default, a reducer retrieves MAP outputs from five (5) mappers simultaneously. The reducer also randomizes the order in which it selects the mappers. This is done in order to prevent a single mapper from being swamped with too much data transfer. Therefore it is difficult to predict the exact order in which the MAP outputs are retrieved. However, predictions can be made with different ranges of error depending on the selected implementation.

The shuffle phase data movement 502 process uses one of three alternative ways to gather data movement information during the shuffling phase. The modify REDUCE task code 601 procedure is the simplest and most accurate way to gather information about shuffling phase data transfers. In this procedure, the REDUCE task is modified so that it reports to the middleware 201 about each of the data transfers it plans to execute. This approach gives a good prediction/estimation about when a data transfer is going to take place. However, this approach requires modifying the code for the REDUCE task which runs on every slave node, potentially creating a deployment barrier.

A second procedure for gathering data movement information is to modify the map/reduce controller 103 code 602. In this procedure, the required information is extracted from the map/reduce controller 103 node. The map/reduce controller 103 knows which MAP tasks finish, and when a REDUCE task instantiates. Therefore, it is possible for the map/reduce controller 103 to predict the source and destination of a data transfer. This approach only requires modifying the instructions of the map/reduce controller 103, while leaving the code for any slave nodes untouched. However, in this procedure, some of the predictions are made too early compared to when the actual transfer takes place because the order in which reducers fetch MAP output is randomized to avoid congesting MAP tasks.

A third procedure for gathering data movement information is by running agents that continuously scans log files 603. In this procedure, no HADOOP map/reduce code modification is necessary. By retrieving the hostname/IP information of the MAP tasks, it is also possible to extract information about the shuffling phase data transfer. Therefore, agents that continuously scan the map/reduce controller 103 log files are implemented to determine which MAP tasks have completed their task. This information is used to query worker nodes on which maps ran to retrieve the length of the MAP output for a given REDUCE task (determined by its partition ID). As described previously, each mapper partitions its output based on the number of REDUCE tasks and stores its output locally. A reducer can query the mapper and get the size of the MAP output. After determining which MAP tasks are finished and which reducer tasks have started, the agent queries the mapper to gather the shuffle phase data movement. Finally, the agent sends this information to the software middleware 201 for processing. This approach requires no map/reduce code modification, but experiences the same challenge as the second approach because reducers randomize the order is which they retrieve MAP outputs.

The three procedures for gathering data movement information achieve the same functionality, but each procedure has its own advantages and disadvantages. In practical deployment settings, the approach that is the most appropriate for the application context and usage scenario is selected. In any of the three alternative implementations, flow information is periodically transferred from the data collector module 302 to the middleware 201, which preferably resides on a separate server.

All the data movement information collected by the data collector module 302 is further processed by the network scheduling engine 301, which assembles the data movement information and adaptively reconfigures the network to resolve congestions. The network scheduling engine 301 includes three components: network demand estimation 701, network hotspot detection 702, and network flow scheduling 703.

The network demand estimation 701 procedure takes as input the flow source/destination information obtained from the shuffle phase data movement 502 procedure, and translates it into the network traffic demand. Based on additive increase multiplicative decrease (AIMD) behavior of TCP and the model of max-min fairness, the natural network demand of each source-destination pair is then dynamically estimated.

The network hotspot detection 702 procedure is based on natural network demand (from network demand estimation 701 procedure). The network hotspot detection 702 procedure determines which network link is congested. In this procedure, each flow has its own default route. For each network link, the network scheduling engine 301 sums up the natural demand of all flows traversing this link and examines whether the aggregate natural demand exceeds the capacity of the given link. If it does, this link is labeled as congested and the network flow scheduling 703 procedure is invoked to resolve the congestion.

Since network flows continuously start and finish, the traffic matrix obtained from the data collector module 302 is not static. In the network flow scheduling 703 procedure, in addition to flow source/destination information, the network scheduling engine 301 also extracts flow transfer status. Specifically, each flow has three timestamps, t_add, t_start, and t_end, respectively representing the time instant when a future flow is inferred (i.e., added to the list), when the transfer actually takes place, and when the transfer terminates. Based on the three timestamps, the status of a given flow can be determined as follows:

If t_add !=Φ, and t_start=t_end=Φ, where “Φ” represents that the metric is empty or uninitialized, the flow is just detected, but the transfer has not started yet, and flows are labeled as “Pending.” If t_add !=Φ, t_start !=Φ, and t_end=Φ, the flow transfer has started, and flows are labeled as “Serving.” If t_end !=Φ, the flow transfer has finished, and flows are labeled as “Terminated.”

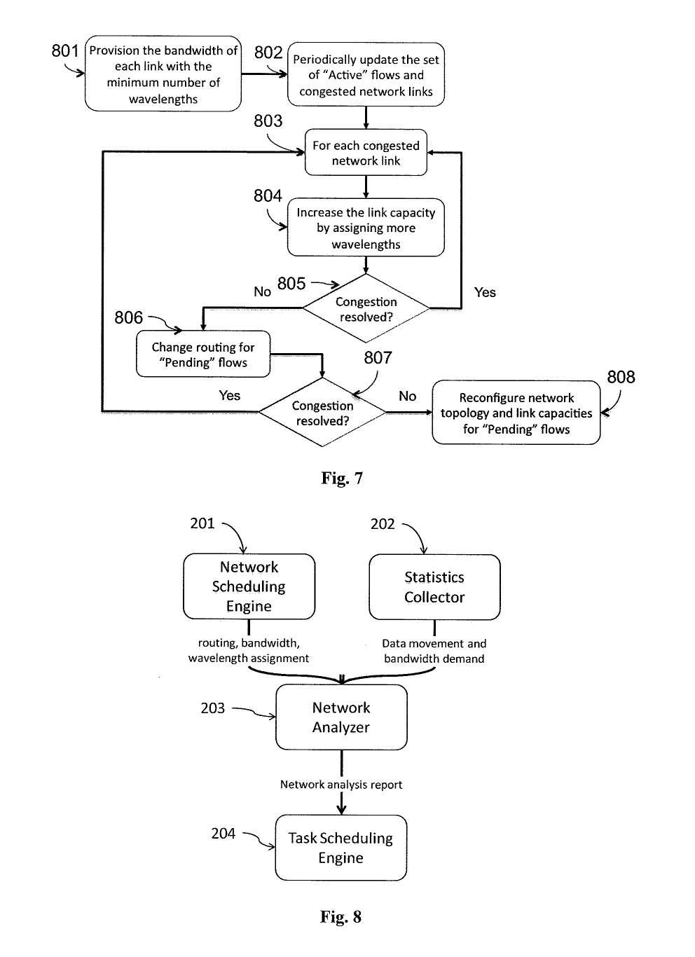

The combined set of “Pending” and “Serving” flows are called “Active” flows. In the described system, the set of “Serving” flows have the highest priority, and should not be interrupted by changing network routing, topology, or wavelength assignment. The set of “Pending” flows are those that have been provisioned the necessary routing paths and link capacities, but the actual transfers have not yet started. Therefore, these flows can be rerouted or reconfigured. This procedure is described in further detail referring to the flowchart of FIG. 7.

At step 801, the middleware 201 first provisions the network bandwidth and topology for the set of “Active” flows with the minimum number of wavelengths. In step 802, the middleware 201 continuously updates the set of “Active” flows as flows join and leave. If network hotspots are identified in step 803, the network scheduling engine 301, in step 804, first tries to resolve congestion by assigning unallocated wavelengths to the congested links. If congestion persists, in step 806 the network scheduling engine 301 tries to change the routing paths of the “Pending” flows that traverse the congested links. If congestion remains unresolved, in step 808 the network scheduling engine 301 reconfigures the optical network switching fabric 205 (including topology and link capacities) for the set of “Pending” flows that traverse the congested links. During the entire process, the set of “Active” flows are preferably not affected. All the actions are fed into the optical switching controller 204, which translates them into the implementable commands according to the physical construction of the optical network switching fabric 205. The data collector module 302 and network scheduling engine 301 of the middleware 201 together dynamically provision and optimize the network based on the obtained traffic movement information.

Returning now to FIG. 3, the remaining components of the middleware 201 are now described. The network analyzer 303 and the task scheduling engine 304 together dynamically adjust the task scheduling of the map/reduce controller 103 based on the network situation. If after the network provisioning and reconfiguration processes conducted by the network scheduling engine 301, the network is not congestion free, the network analyzer 303 of the middleware 201 preferably re-examines the network and determines what set of paths/links are causing congestion to what set of tasks.

The process performed by the network analyzer 303 is described with reference to FIG. 8. The network analyzer 203 takes two inputs: (1) network configuration (i.e., routing, topology, wavelength assignment, etc.) generated by the network scheduling engine 301, and (2) data movement and network traffic demand generated by the data collector module 302. The network analyzer 303 performs a process similar to that of the network hotspot detection 702 process to generate a network situation analysis report.

The network situation analysis report generated by the network analyzer 303 are taken as input by the task scheduling engine 304. The task scheduling engine 304 attempts to resolve network congestion by rescheduling the tasks of the map/reduce controller 103. The rescheduling actions can be either temporal (e.g., by initiating the tasks at a different time, by pacing tasks to smooth out the data transmissions, or by terminating and restarting certain tasks to allow other tasks to meet their respective deadlines), spatial (e.g., by placing task nodes onto different physical servers), or both. Similar to the network scheduling engine 301, one principle of the task scheduling engine 304 is not to interrupt tasks that are currently executing, unless these tasks are significantly affecting other tasks and have to be rescheduled.

So far, a middleware 201 for a map/reduce computing platform deployed on a reconfigurable optical switched network has been described. The middleware 201 links together the map/reduce controller 103 and the optical switch controller 204 such that the optical switch controller 204 is able to obtain more accurate network data movement information to perform the network optimization process in a proactive manner, and at the same time the map/reduce controller 103 is able to utilize the network traffic information obtained from the middleware 201 to improve its task scheduling and dispatching process. Thus, the described middleware 201 significantly improves the operation of the optical switch controller 204, which relies on network monitoring data and takes actions reactively, and the map/reduce controller 103, which currently is essentially network oblivious. This nonintrusive middleware 201 imposes negligible overhead to the running applications and system infrastructure, and therefore can be easily deployed in production environments.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for improving performance of a distributed computing task by improving data flow through an interconnected optical switching fabric, the method comprising:
monitoring network traffic flows among a plurality of computing devices performing the distributed computing task, the network traffic flows passing through the interconnected optical switching fabric;
determining estimated network congestion of the network traffic flows through the interconnected optical switching fabric based upon the monitored network traffic flows among the plurality of computing devices; and
reconfiguring the network traffic flows through the interconnected optical switching fabric to reduce the estimated network congestion.

2. The method of claim 1 wherein the distributed computing task is a MapReduce application.

3. The method of claim 1 wherein monitoring network traffic flows among the plurality of computing devices performing the distributed computing task comprises:
retrieving information regarding network traffic flows from a controller.

4. The method of claim 1 wherein monitoring network traffic flows among the plurality of computing devices performing the distributed computing task comprises:
retrieving information regarding source and destination, data volume, and transfer progress of network flows.

5. The method of claim 1 wherein monitoring network traffic flows among the plurality of computing devices performing the distributed computing task comprises:
aggregating the network traffic volume of all network traffic flows traversing each of a plurality of links between pairs of computing devices of the plurality of computing devices.

6. The method of claim 1 wherein monitoring network traffic flows among the plurality of computing devices performing the distributed computing task comprises at least one of:
monitoring expected network traffic flows for distributed file system operations; or
monitoring expected network traffic flows for transferring data to servers performing reduce operations.

7. The method of claim 1 wherein monitoring network traffic flows among the plurality of computing devices performing the distributed computing task comprises:
analyzing log files related to one or more computing devices of the plurality of computing devices.

8. The method of claim 1 wherein determining estimated network congestion of the network traffic flows through the interconnected optical switching fabric based upon the monitoring network traffic flows among the plurality of computing devices comprises:
analyzing the current network topology and data movement prediction data.

9. The method of claim 1 wherein determining estimated network congestion of the network traffic flows through the interconnected optical switching fabric based upon the monitoring network traffic flows among the plurality of computing devices comprises:
identifying network segments where performance degradation is occurring or is likely to occur.

10. The method of claim 1 wherein determining estimated network congestion of the network traffic flows through the interconnected optical switching fabric based upon the monitoring network traffic flows among the plurality of computing devices comprises:
analyzing network bandwidth demand between a plurality of pairs of computing devices of the plurality of computing devices.

11. The method of claim 1 wherein reconfiguring the network traffic flows through the interconnected optical switching fabric comprises:
reconfiguring the interconnected optical switching fabric.

12. The method of claim 1 wherein reconfiguring the network traffic flows through the interconnected optical switching fabric to reduce the estimated network congestion comprises:
increasing the capacity of a link.

13. The method of claim 1 wherein the interconnected optical switching fabric uses wavelength-division multiplexing and reconfiguring the network traffic flows to reduce the estimated network congestion comprises allocating additional wavelengths to a link.

14. The method of claim 1 wherein the interconnected optical switching fabric uses at least one of wavelength-selective switching or optical space switching.

15. The method of claim 1 wherein reconfiguring the network traffic flows through the interconnected optical switching fabric to reduce the estimated network congestion comprises:
changing network traffic flow routing paths for pending network traffic flows.

16. The method of claim 1 wherein reconfiguring the network traffic flows through the interconnected optical switching fabric to reduce the estimated network congestion comprises at least one of:
rescheduling one or more tasks of the distributed computing task on one or more computing devices of the plurality of computing devices;
pacing one or more tasks to smooth out data transmission;
terminating and restarting one or more tasks to allow other tasks to meet their respective deadlines; or
assigning one or more tasks to different computing devices of the plurality of computing devices.

17. The method of claim 1 wherein reconfiguring the network traffic flows through the interconnected optical switching fabric to reduce the estimated network congestion comprises:
selecting a new task scheduling policy.

18. The method of claim 1 further comprising:
transmitting data regarding the reconfiguration of the network traffic flows through the interconnected optical switching fabric.

19. A system for distributed computing comprising:
a plurality of computing devices configured to perform portions of a distributed computing task;
an interconnected optical switching fabric for facilitating transfer of data among the plurality of computing devices;
a controller comprising:
a memory for storage of data and program code;
a network interface for sending data to, and receiving data from, at least the plurality of computing devices; and
at least one processor configured to execute program code stored in the memory to perform the steps of:
monitoring network traffic flows among the plurality of computing devices performing the distributed computing task, the network traffic flows passing through the interconnected optical switching fabric;
determining estimated network congestion of the network traffic flows through the interconnected optical switching fabric based upon the monitoring network traffic flows among the plurality of computing devices; and
reconfiguring the network traffic flows through the interconnected optical switching fabric to reduce the estimated network congestion.

20. A method for optimizing an interconnected optical switching fabric, the method comprising:
monitoring expected traffic flows between a plurality of nodes of a map/reduce application in the interconnected optical switching fabric;
determining one or more optimizations for the interconnected optical switching fabric based on the monitoring of the expected traffic flows; and
reconfiguring the interconnected optical switching fabric to implement the one or more determined optimizations.
